(19) United States
(12) Patent Application Publication
(10) Pub. No.: US 2007/0258232 A1
(43) Pub. Date: Nov. 8, 2007

(54) Illuminated support structure

(76) Inventors: Richard Prince JR., Milwaukee, WI (US); Richard Prince SR., Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/416,964

(22) Filed: May 3, 2006

(51) Int. Cl. F21S 8/00

(52) U.S. Cl. 362/146; 362/431

(57) ABSTRACT

An illuminated support structure comprised of: a first and second vertical post; a top rail and bottom rail positioned between the posts; a plurality of spindles positioned at intervals between the and bottom rails and capable of providing intervals of unlit areas between each spindle; at least one light source for each spindle; and a power source to provide power to each of said at least one light source.

### FIELD OF THE INVENTION

This invention relates generally to the field of support structures and specifically to support structures that can be illuminated.

### BRIEF DESCRIPTION OF THE DRAWINGS

FIG. 1 is a front view of one embodiment of one section of an illuminated support structure.

FIG. 2 is a cross-sectional view of one embodiment of a spindle and a portion of the bottom rail.

FIG. 3 is a top cross-sectional view of one embodiment of the bottom rail.

### DETAILED DESCRIPTION OF EMBODIMENTS OF THE INVENTION

The drawings include exemplary embodiments to the invention, which may be embodied in various forms. It is to be understood that in some instances various aspects of the invention may be shown exaggerated or enlarged to facilitate an understanding of the invention. Furthermore, with reference to the drawings, the reader should understand that like reference numerals in different drawings refer to the like elements and components of the invention. Moreover, it should be noted that each embodiment of the invention is not depicted by the figures.

Detailed descriptions of the embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

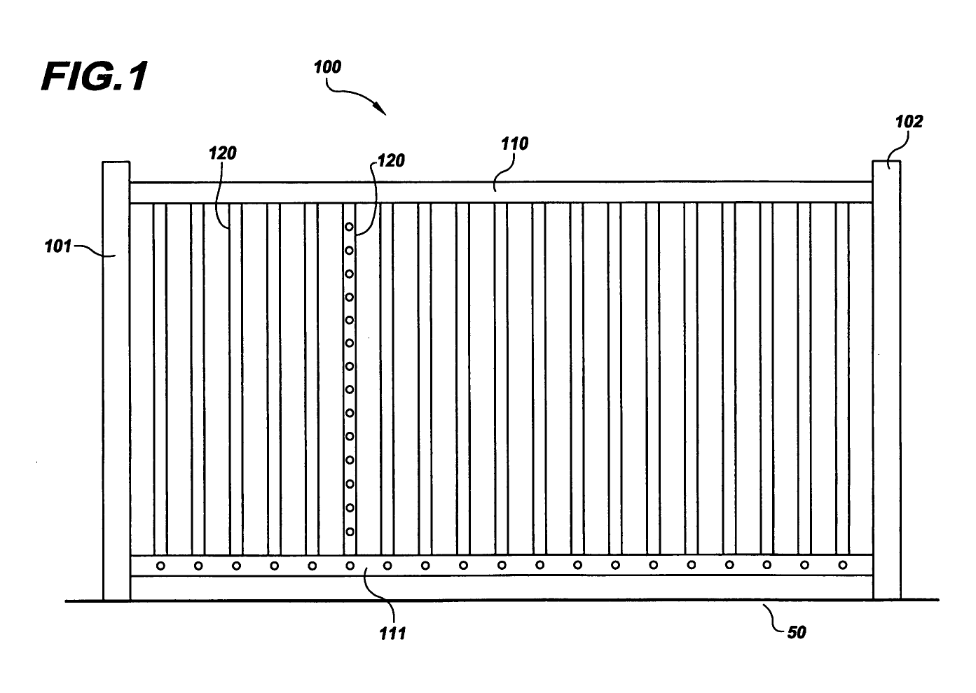

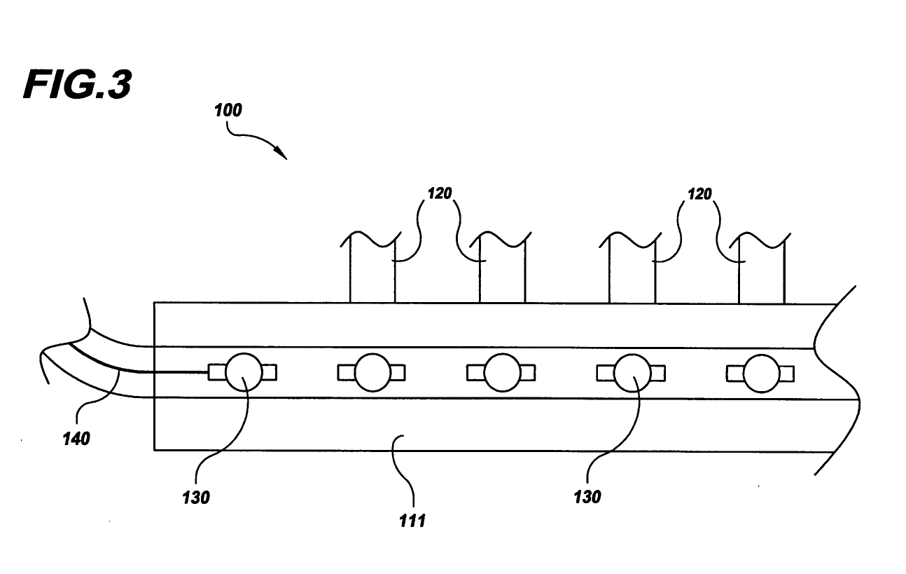

FIG. 1 is a front view of one embodiment of one section of an illuminated support structure 100 used as a hand railing. The representative section of FIG. 1 has two support posts 101, 102, each secured to a lower surface 50 and connected by top rail 110 and bottom rail 111. Support posts 101, 102 are substantially vertical, and top rail 110 and bottom rail 111 are substantially horizontal. Positioned between top rail 110 and bottom rail 111, is a series of spindles 120 (as discussed in greater detail with respect to FIG. 3). In the embodiment shown, spindles 120 are spaced at six inch (6″) intervals. However, spindles 120 can be spaced at alternate intervals, as discussed in greater detail infra. Also in the embodiment shown, a light source (shown and described in detail infra) is positioned at the bottom of each spindle 120. However, the light sources may be positioned at the top or at any point on spindle 120. Each light source is connected to a power source. In the embodiment shown, each light source is connected to one another in the series and connected to a single power source. However, multiple sources can be used. In addition, the power source may be electrically connected to the light source by wires running through posts 101, 102, top rail 110, bottom rail 111, or any individual spindle 120. The amount of light emitted from spindles 120 and the light source retain the visual effect of vertically lit structures with unlit intervals between 120.

In the embodiment shown, top rail 110 and bottom rail 111 are horizontally positioned between posts 101, 102. However, top rail 110 and bottom rail 111 could alternately be angled at any angle between posts 102, 102 where, for example, post 101 is positioned at or near the top of a stairway and post 102 is positioned at or near the bottom of a stairway. Top rail 110 and bottom rail 111 would then be positioned at an angle generally parallel to the incline of the stairway.

In one embodiment, the light source is sufficient to illuminate the surrounding area yet maintains an appearance of intervals darkness between each spindle.

Posts 101, 102 are made of any sufficiently durable material capable of functioning as support. For those embodiments of illuminated support structure 100 in which the electrical wires enter illuminated support structure 100 through posts 101, 102, posts 101, 102 should be made of a sufficiently durable material capable of maintaining its support characteristics when molded or formed into a structure to accommodate insertion of wiring from an electrical source. In the embodiment shown, posts 101, 102 are made of wood, but alternately can be made of metal, plastic, acyclic polycarbon hydrocarbyl, stone, concrete, plaster, and combinations thereof.

Each spindle 120 is made of durable, rigid and completely or partly transparent material capable of transmitting light and maintaining a shape when formed into a hollow structure to the transmission of light along the length of each spindle 120. However, in other embodiments of the invention, light may be emitted solely through apertures in spindle 120. In the embodiment shown, spindle 120 is made of plastic, but alternatively can be made of another plastic (clear or partially opaque), resin, acyclic polycarbon hydrocarbyl, or any material through which light can pass or made of any material permitting the creation of apertures permitting light to pass through. The light source may also be positioned at the top or at any other point along the length of spindle 120. In alternate embodiments of illuminated support structure 100, the light source may be positioned at the top of spindle 120 and within top rail 110, at any other point along spindle 120, or may be at multiple positions above, below, and/or within spindle 120.

In the embodiment shown in FIG. 1, spindles 120 are clear and cylindrically shaped. However, spindles could be any color, tint or level of transparency and of any regular or irregular shape or configuration. Spindles 120 may be solid or have apertures.

The embodiment of the illuminated support structure 100 is ten feet (10′) in length and thirty-six inches (36″) high, with two posts 101, 102, and nineteen spindles 120 spaced at least six inches (6″) apart. However, it should be understood that spindles 120 could be spaced at other intervals, both less than and greater than the six inch (6″) intervals shown in the embodiment of FIG. 1, and that spindles 120 could be evenly or irregularly spaced apart from one another. One of ordinary skill in the art will further recognize that other dimensions of illuminated support structure 100, alternative number of posts 101, 102 and alternate configurations of spindles 120 could be employed, including configurations where spindles 120 are arranged in directions other than vertically, and configurations where spindles 120 are irregularly spaced.

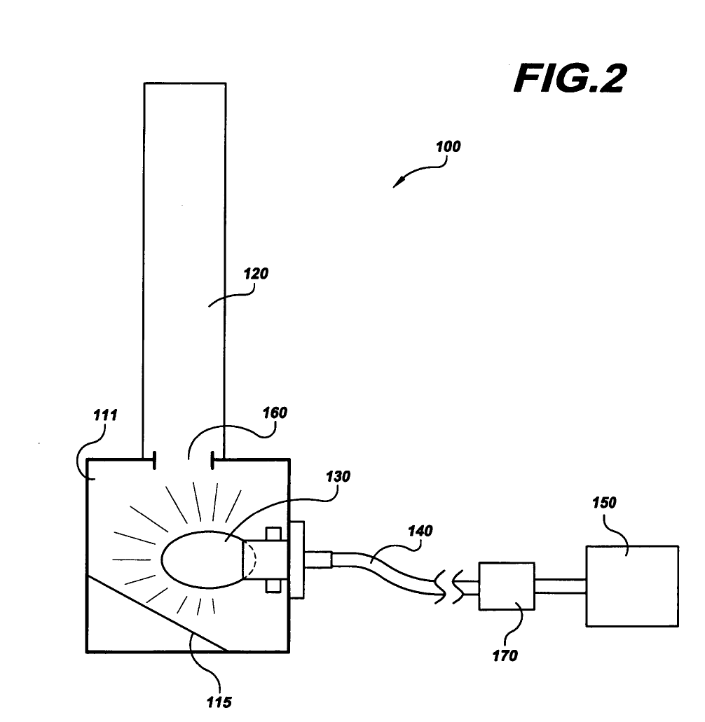

FIG. 2 is a cross-sectional view of the embodiment of spindle 120 and bottom rail 111 shown in FIG. 1. In this embodiment light source 130 is positioned within bottom rail 111 and connected to power source 150 by wire 140. However, light source 130 can be positioned at any point within rail 111 or within spindle 120. Also visible in FIG. 2 is aperture 160, which permits light emitted from light source 130 to enter spindle 120 and be visible from illuminated support structure 100.

Visible in FIG. 2 is light source 130. In this embodiment light source 130 is an incandescent light bulb without pigment. However other embodiments of light source 130 can include fluorescent light, LED, bug repellent lighting, fiber optic, tinted or colored lighting, energy efficient lighting or any other device capable of emitting or reflecting light, including reflective tape or particles of a reflective substance.

Also visible in FIG. 2 is reflective surface 115 positioned below light source 130 to enhance the illuminating feature of illuminated support structure 100. One of ordinary skill in the art will recognize that reflective surface 115 could be in alternate positions or alternate configurations, including an embodiment of illuminated support structure 100 without a reflective surface. There may also be multiple reflective surfaces, including particles of a substance capable of being reflective. The reflective surface or surfaces may be positioned at any angle.

Power source 150 is in the embodiment shown, an AC power source. An alternate embodiment power source may be a DC power source, Uninterruptible Power Supply (UPS), battery, solar power, hydro-electric power, all types of generators or any other power source capable of delivering power to light source 130.

Also shown in FIG. 2 is control device 170 which permits power source 150 to be turned on and off, and permits control, synchronization or timed use of individual light sources 130 or groups of light sources 130. Control device 170 may utilize computer code, remote access technology or other technology to coordinate, control or time the functioning of individual light sources 130 or groups of light sources 130. Yet another embodiment does not include control device 150.

FIG. 3 is a top cross-sectional view of one embodiment of bottom rail 111 showing light sources 130 electrically connected in series and positioned within bottom rail 111.

While several embodiments of the present invention have been shown and described, it is to be understood that the invention is not limited thereto, but is susceptible to numerous chanqes and modifications as known to a person skilled in the art, and it is intended that the present invention not be limited to the details shown and described herein, but rather cover all such changes and modifications as are obvious to one of ordinary skill in the art.

What is claimed is:

1. An illuminated support structure comprised of:
a first vertical post and a second vertical post;
a top rail and a bottom rail substantially horizontally disposed between said first post and said second post;
a plurality of spindles positioned at intervals between said top rail and said bottom rail, each of said plurality of spindles positioned between said first vertical post and said second vertical post and capable of providing intervals of unlit areas between each of said plurality of vertical spindles; and
at least one light source for each of said plurality of vertical spindles, said structure adapted to be electrically connected to a power source to provide power to each of said at least one light source.

2. The structure of claim 1, wherein each of said plurality of spindles is substantially vertical.

3. The structure of claim 1, wherein said first vertical post, said second vertical post, said top rail, and said bottom rail are made of a material selected from a group comprised of wood, metal, plastic, acyclic polycarbon hydrocarbyl, stone, fiberglass, resin, concrete, plaster, and combinations thereof.

4. The structure of claim 1, wherein each of said plurality of spindles is at least partially transparent.

5. The structure of claim 4, wherein each of said plurality of spindles is colored or tinted.

6. The structure of claim 1, wherein each of said plurality of is non-transparent and further includes at least one aperture to permit transmission of light therethrough.

7. The structure of claim 1, wherein said structure is further comprised of a control device, said control device controlling actions selected from a group comprised of an on/off function, synchronization of said at least one light source, and timed use of said at least one light source.

8. The structure of claim 1, wherein said at least one light source is selected from a group comprised of fluorescent light, LED, bug repellent lighting, fiber optic, tinted lighting, colored lighting, energy efficient lighting, and combinations thereof.

9. The structure of claim 1, wherein said power source is selected from a group comprised of an AC power source, a DC power source, an Uninterruptible Power Supply, a battery, solar power, hydroelectric power, and combinations thereof.

10. The structure of claim 1, wherein said illumination support structure provides general illumination of an area surrounding said illumination support structure.

11. The structure of claim 1, wherein each of said plurality of spindles provides support to said top rail.

12. An illuminated support structure comprised of:
a first vertical post and a second vertical post;
a top rail and a bottom rail, substantially horizontally disposed between said first post and said second post;
a plurality of spindles positioned at intervals between said top rail and said bottom rail, each of said plurality of spindles substantially providing support to said top rail;
at least one light source for each of said plurality of spindles; and
a power source to provide power to each of said at least one light source;
said illumination support structure capable of providing general illumination of an area surrounding said illumination support structure.

13. The structure of claim 12, wherein said first vertical post, said second vertical post, said top rail, and said bottom rail are made of a material selected from a group comprised of wood, metal, acyclic polycarbon hydrocarbyl, stone, concrete, plaster, fiberglass, resin, and combinations thereof.

14. The structure of claim 12, wherein each of said plurality of spindles is at least partially transparent.

15. The structure of claim 12, wherein each of said plurality of spindles is colored or tinted.

16. The structure of claim 12, wherein each of said plurality of spindles is non-transparent and further includes at least one aperture to permit transmission of light therethrough.

17. The structure of claim 12, wherein each of said plurality of spindles is capable of providing intervals of unlit areas between each of said plurality of spindles.

18. The structure of claim 12, wherein said structure is further comprised of a control device, said control device controlling actions selected from a group comprised of an on/off function, synchronization of said at least one light source, and timed use of said at least one light source.

19. The structure of claim 12, wherein said at least one light source is selected from a group comprised of fluorescent light, LED, bug repellent lighting, fiber optic, tinted lighting, colored lighting, energy efficient lighting, and combinations thereof.

20. The structure of claim 12, wherein said power source is selected from a group comprised of an AC power source, a DC power source, an Uninterruptible Power Supply, a battery, solar power, hydroelectric power, and combinations thereof.

21. An illuminated support structure comprised of:
a first vertical post and a second vertical post;
a top rail and a bottom rail, disposed between said first post and said second post;
a plurality of spindles positioned between said top rail and said bottom rail and between said first vertical post and second vertical post, and capable of providing intervals of unlit areas between each of said plurality of spindles and said second vertical post and each providing support to said top rail; and
at least one light source for each of said plurality of spindles, said structure adapted to be electrically connected to a power source to provide power to each of said at least one light source and capable of providing general illumination of an area surrounding said illumination support structure.

22. The structure of claim 21, wherein said first vertical post, said second vertical post, said top rail, and said bottom rail are made of a material selected from a group comprised of wood, metal, plastic, acyclic polycarbon hydrocarbyl, stone, concrete, plaster, fiberglass, resin, and combinations thereof.

23. The structure of claim 21, wherein each of said plurality of substantially vertical spindles is at least partially transparent.

24. The structure of claim 21, wherein each of said plurality of substantially vertical spindles is colored or tinted.

25. The structure of claim 21, wherein each of said plurality of substantially vertical spindles is non-transparent and further includes at least one aperture to permit transmission of light therethrough.

26. The structure of claim 21, wherein said structure is further comprised of a control device, said control device controlling actions selected from a group comprised of an on/off function, synchronization of said at least one light source, and timed use of said at least one light source.

27. The structure of claim 21, wherein said at least one light source is selected from a group comprised of fluorescent light, LED, bug repellent lighting, fiber optic, tinted lighting, colored lighting, energy efficient lighting, and combinations thereof.

28. The structure of claim 21, wherein said power source is selected from a group comprised of an AC power source, a DC power source, an Uninterruptible Power Supply, a battery, solar power, hydro-electric power, and combinations thereof.
